(19) United States
(12) Patent Application Publication
(10) Pub. No.: US 2006/0218605 A1
(43) Pub. Date: Sep. 28, 2006

(54) Transmission apparatus

(75) Inventors: Kentaro Hirao, Osaka (JP); Yuji Tanikawa, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/387,783

(22) Filed: Mar. 24, 2006

(30) Foreign Application Priority Data
Mar. 25, 2005 (JP) 2005-089956
Mar. 9, 2006 (JP) 2006-064490

(51) Int. Cl. H04N 7/173; H04N 7/16

(52) U.S. Cl. 725/93; 725/94; 725/96; 725/114; 725/115; 725/145; 725/144; 725/100; 725/131

(57) ABSTRACT

A transmission apparatus which alleviates, compared to conventional apparatuses, a processing burden such as transmission position management for terminals, which is required for video data distribution in a video-on-demand system distributing video data according to requests from user-side terminals.

A transmission apparatus 100 uses an accumulation buffer control subunit 105 and a user buffer control subunit 106 to manage an accumulation buffer 102 of the transmission apparatus and a user buffer 153 of a playback apparatus. Upon receipt of a video data transmission request from the playback apparatus 150, the transmission apparatus 100 determines an accumulation buffer to be assigned to the playback apparatus. If a plurality of playback apparatuses are using the same accumulation buffer, amounts of data transmitted to the playback apparatuses are controlled while referencing user buffers 153 of the playback apparatuses, such that transmission positions of video data transmitted to the playback apparatuses are aligned.

This application is based on application Nos. 2005-089956 and 2006-64490 filed in Japan, the contents of which are hereby incorporated by reference.

### BACKGROUND OF INVENTION

1. Field of the Invention

The present invention relates to a video-on-demand system that provides content to a plurality of user-side terminals, and in particular to a content transmission method.

2. Related Art

In conventional video-on-demand systems, if there are content transmission requests from a plurality of user-side terminals, content playback positions will differ for each terminal. The transmission apparatus that provides content therefore retains buffer areas for data accumulation on the transmission apparatus side for only the number of requesting terminals, reads sequential data from a storage medium storing the content and accumulates the read sequential data to the buffer areas, and transmits the accumulated data to the terminals as stream data (see patent document 1).

Patent document 1: Japanese Patent Application Publication No. H08-23531 (1996)

In the above structure, however, the transmission apparatus must manage a content transmission position for each terminal when content request positions from terminals are different. As the number of terminals increases, the transmission apparatus suffers a progressively growing burden, including the increasing complexity of managing transmission positions for stream data transmitted to the terminals, and the rising number of buffer areas to be retained.

### SUMMARY OF INVENTION

The present invention has therefore been achieved in view of the above problem, and aims to provide a transmission apparatus that alleviates, compared to conventional apparatuses, the processing burden required for content distribution, even when there are content transmission requests from a plurality of user-side terminals, by controlling transmission positions of stream data transmitted to the terminals.

In order to solve the above issue, the transmission apparatus pertaining to the present invention is connected to a plurality of playback apparatuses via a network, and sequentially transmits stream data according to requests of individual playback apparatuses from among the plurality of playback apparatuses, and includes a storage unit operable to prestore the stream data; a management unit operable to manage a transmission position for each of the plurality of playback apparatuses, the transmission position showing, on a time-axis of the stream data, a position at which transmission is being performed; a detection unit operable to detect that the transmission positions for at least two of the playback apparatuses are within a predetermined range; and a transmission control unit operable to control transmission of the stream data so as to align the transmission positions for the at least two playback apparatuses.

According to this structure, even if there are content transmission requests from the plurality of user-side terminals, and content request positions differ for each of the terminals, it is possible to bring the transmission positions of content to be transmitted to the terminals closer together by, for example, adjusting transmission amounts of the stream data and controlling transmission of the stream data so as to be in a different amount for each of the terminals, thereby eventually enabling the content transmission positions to be aligned.

Furthermore, aligning the transmission positions of content being transmitted to the terminals enables the same stream data to be transmitted from a single buffer to the terminals in one transmission, and compared with a conventional case of providing a buffer for each terminal and transmitting stream data at different transmission positions, enables the reduction of accesses to the recording medium and the cutback of buffer areas, and enables the alleviation of the processing burden on the transmission apparatus necessary for transmission of the stream data, compared to conventional apparatuses.

Also, the transmission control unit may perform the control so as to align the transmission positions for the at least two playback apparatuses, by adjusting, based on the transmission positions thereof that are managed by the management unit, a transmission amount of the stream data to be transmitted within a predetermined time period.

According to this structure, adjusting the stream data transmission amount to be transmitted within a predetermined time enables the transmission positions of stream data being transmitted to the terminals to be aligned in the predetermined time.

Also, the transmission control unit may perform the transmission amount adjustment by specifying, from among the at least two playback apparatuses, a reference playback apparatus to be a reference for transmission position alignment, and with respect to another playback apparatus from among the at least two playback apparatuses, increasing or decreasing the transmission amount by an amount corresponding to a difference between the transmission position for the reference playback apparatus and the transmission position for the other playback apparatus.

According to this structure, even if stream data transmission positions are different for each terminal, controlling the transmission amount of stream data being transmitted to terminals other than the predetermined terminal enables the stream data transmission positions of the other terminals to become aligned with the transmission position of the predetermined terminal, which is useful if, for example, it is desirable to align transmission positions with the transmission position of a designated terminal.

Also, each of the plurality of playback apparatuses may include an accumulation unit operable to receive up to a given amount of the stream data and accumulate the received stream data; the transmission control unit may add or subtract a predetermined adjustment amount to/from a predetermined reference transmission amount to perform sequential transmission of the stream data, the transmission apparatus may further include a user buffer management unit operable to acquire, for each of the plurality of playback apparatuses, an accumulation position showing, on the time-axis of the stream data, a position at which the accumulation unit is performing reception and accumulation, and a buffer capacity showing an amount of the stream data that can be accumulated by the accumulation unit, and manage the received accumulation positions and the received buffer capacities; and a judgment unit operable to judge, based on the accumulation positions and the buffer capacities, whether the accumulation units of the at least two playback apparatuses can accumulate the adjustment amount, and the transmission control unit may perform the transmission amount adjustment only if the judgment by the judgment unit is affirmative.

According to this structure, if the terminal uses a buffer that accumulates stream data to receive the stream data, the transmission apparatus can judge the status of the buffers on the terminal side to control the transmission amount of stream data transmitted to the terminals, and can control the amount of stream data transmitted to the terminals while, for example, preventing the transmission of an amount of stream data that cannot be fully stored in a terminal-side buffer.

Also, the transmission control unit may perform the transmission amount adjustment by, from among the at least two playback apparatuses, increasing the transmission amount with respect to a playback apparatus which pertains to a transmission position that is behind a predetermined position on the time-axis of the stream data, and decreasing the transmission amount with respect to a playback apparatus which pertains to a transmission position that is ahead of the predetermined position on the time-axis of the stream data.

According to this structure, the transmission positions of the stream data being transmitted to the terminals can be aligned with a predetermined position, which is useful if, for example, a transmission position to be aligned with is known in advance.

Also, the transmission control unit may perform the transmission amount adjustment by transmitting stream data from which a part is omitted to, from among the at least two playback apparatuses, a playback apparatus pertaining to a transmission position that is behind on the time-axis of the stream data compared with another one of the at least two playback apparatuses.

According to this structure, even if the transmission positions of the terminals cannot be aligned by increasing or reducing the transmission amount of stream data to be transmitted to the terminals, as in the exemplary case of not being able to increase the transmission amount of stream data to be transmitted to a terminal because there is insufficient buffer space on the terminal side, omitting a portion of stream data being sequentially transmitted to a terminal with a later transmission position compared with another terminal enables bringing one content transmission position closer to the transmission position of another terminal gradually, at the rate of the omitted portion, and repeatedly performing the omission allows gradually bringing the one transmission position closer to the transmission position of the other terminal.

Also, the present invention is a content distribution system including a transmission apparatus that sequentially transmits stream data to a plurality of playback apparatuses according to requests from the plurality of playback apparatuses, and the plurality of playback apparatuses that receive the stream data requested from the transmission apparatus and playback the received stream data, each of the plurality of playback apparatuses including an accumulation unit operable to receive up to a given amount of the stream data and accumulate the received stream data; and a distribution unit operable to distribute, based on an instruction of the transmission apparatus, the stream data accumulated by the accumulation unit to another of the plurality of playback apparatuses, and the transmission apparatus including a storage unit operable to prestore the stream data; a user buffer management unit operable to acquire and manage, for each of the plurality of playback apparatuses, an accumulation position showing, on a time-axis of the stream data, a position at which the accumulation unit is performing reception and accumulation, and a buffer capacity showing an amount of the stream data that can be accumulated by the accumulation unit; an accumulated data detection unit operable, if there is a transmission request for the stream data from a first playback apparatus, to detect that the stream data requested by the first playback apparatus has been accumulated by a second playback apparatus; and a playback apparatus control unit operable, if the detection has been performed, to control the second playback apparatus such that the distribution unit thereof distributes the stream data from the second playback apparatus to the first playback apparatus.

According to this structure, if stream data requested by a terminal is already accumulated in the buffer of another terminal, the requested stream data can be caused to be distributed from the other terminal that has the stream data accumulated to the terminal that requested the stream data, thereby eliminating the need to retain a buffer area on the transmission apparatus side for newly transmitting stream data to the terminal. After distributing the stream data from one terminal to another terminal, and the accumulation positions of stream data accumulated in the terminals have been aligned, it is also possible to transmit the same stream data to the terminals that have identical accumulation positions. In other words, the stream data transmission positions of the terminals can be aligned once the accumulation positions are aligned, thereby enabling the alleviation of the processing burden on the transmission apparatus.

Also, segments of the stream data may be defined, the detection unit may perform the detection if a plurality of transmission positions are included in one of the segments, and the transmission control unit may control transmission of the stream data so as to align the transmission positions of the at least two playback apparatuses to a predetermined position in the one of the segments.

According to this structure, it is possible to align the transmission positions of terminals in a segment, thereby allowing transmission positions targeted for alignment to be managed on the transmission apparatus side in a number of predetermined segments.

Also, after the transmission positions for the at least two playback apparatuses have been aligned by the transmission control unit, a portion that is a predetermined amount of the stream data may be read from the storage unit, the portion may be input to a single FIFO buffer, and the stream data may be output from the FIFO buffer to the at least two playback apparatuses.

According to this structure, the stream data can be transmitted in one instance from a single buffer after stream data transmission positions of terminals have been aligned, and it is possible to reduce the amount of buffer area necessary for transmission of content compared with the case of retaining a buffer for each terminal, thereby enabling the alleviation of the burden on the transmission apparatus.

However, if stream data is being transmitted to a number of playback apparatuses, and a content transfer request is received from another playback apparatus, the content transfer request may not be able to be handled due to a lack of network bandwidth.

Therefore, the transmission apparatus may further include a bandwidth management unit operable to manage used bandwidth on the network with respect to the stream data at differing transmission positions; a judgment unit operable, if the stream data is being transmitted and a transfer request for the stream data pertaining to another transmission position is newly received, to judge whether a total used bandwidth of the stream data to be transmitted exceeds a total bandwidth of the network; and a bandwidth control unit operable, if the total used bandwidth is judged by the judgment unit to exceed the total bandwidth, to transmit converted stream data on which data conversion processing has been performed to at least one of the plurality of playback apparatuses, such that the total used bandwidth does not exceed the total bandwidth, wherein the transmission control unit may perform the control so as to align the transmission position pertaining to the converted stream data with another one of the transmission positions.

According to this structure, even in the case of stream data not being able to be transmitted to a playback apparatus which has made a content transfer request due to a lack of bandwidth, transmitting stream data on which data conversion processing has been performed enables stream data to be transmitted to as many playback apparatuses as possible.

Also, upon alignment of the transmission position pertaining to the converted stream data with the other one of the transmission positions by the transmission control unit, transmission of the converted stream data may be stopped to free the used bandwidth thereof, and the stream data pertaining to the other one of the transmission positions may be transmitted to the playback apparatus to which the converted stream data was transmitted.

According to this structure, the bandwidth used by the converted stream data can be freed once the transmission position of the converted stream data has been aligned with the transmission position of other stream data, thereby enabling the effective use of network bandwidth. Also, unconverted high quality stream data can be transmitted to the playback apparatus which had been receiving the converted stream data.

### BRIEF DESCRIPTION OF DRAWINGS

These and other objects, advantages, and features of the invention will become apparent from the following description thereof taken in conjunction with the accompanying drawings, which illustrate specific embodiments of the present invention.

In the drawings:

FIG. 1 is a functional block diagram showing a structure of a transmission apparatus 100 and a playback apparatus 150;

FIG. 2 shows a data structure of an accumulation buffer management table 200;

FIG. 3 shows a data structure of a user buffer management table 300;

FIG. 4 is a flowchart showing processing performed by the control unit 104 to determine accumulation buffers to be assigned to playback apparatuses;

FIG. 5 is a flowchart showing aggregation processing;

FIG. 6 is a flowchart showing buffer capacity judgment processing;

FIGS. 7A to 7D show transition states of aligning transmission positions of stream data being transmitted to playback apparatuses;

FIG. 8 shows a data structure of a transmission position management table 800;

FIG. 9 is a flowchart showing omission processing;

FIG. 10 shows a data structure of a second generation distribution management table 1000;

FIG. 11 is a function block diagram showing a structure of the transmission apparatus 100 and a playback apparatus 160 pertaining to embodiment 2;

FIG. 12 is a flowchart showing processing to cause second generation distribution to a playback apparatus;

FIGS. 13A and 13B show the transmission position management table 800 in a case of a single playback apparatus being assigned to a single accumulation buffer;

FIG. 14 is a functional block diagram showing a structure of a transmission apparatus 1400 and a playback apparatus 150 pertaining to embodiment 3;

FIGS. 15A to 15E show a bandwidth management table 1900;

FIG. 16. is a flowchart showing processing related to performing data conversion in accordance with control of a bandwidth control unit 110;

FIG. 17 is a flowchart showing processing related to updating a playback apparatus management table 1900b when transmission positions of stream data have been aligned; and

FIGS. 18A to 18C show bandwidth control performed by the bandwidth control unit 110.

### DETAILED DESCRIPTION OF PREFERRED EMBODIMENTS

### Embodiment 1

A transmission apparatus pertaining to an embodiment of the present invention is described below.

Structure

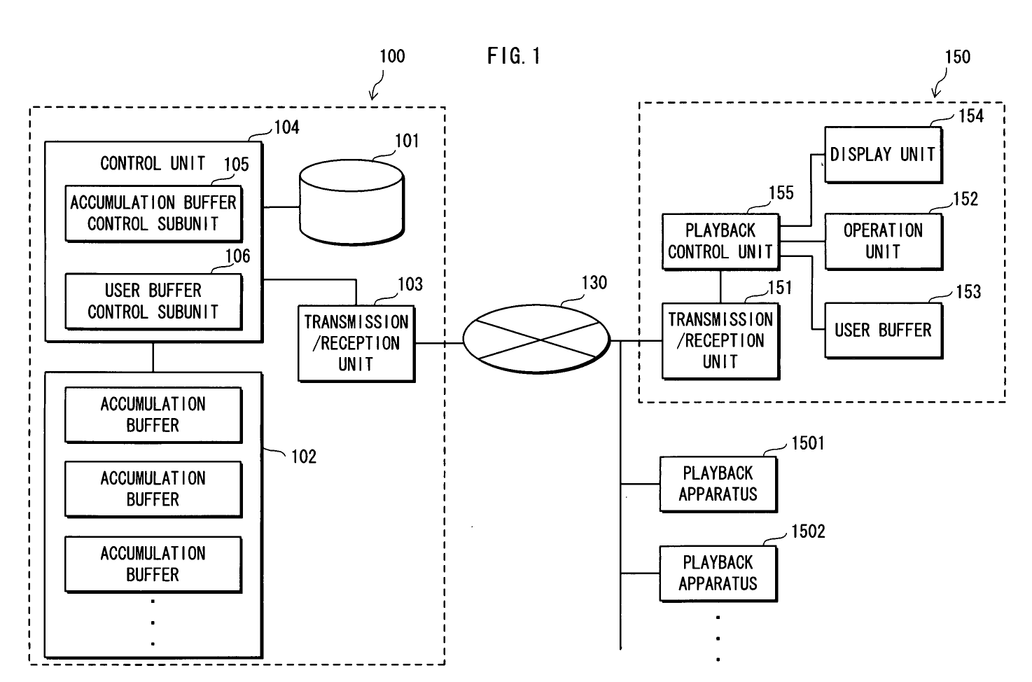

FIG. 1 is a functional block diagram showing a structure of a transmission apparatus 100 and a playback apparatus 150 of the present embodiment.

As shown in the figure, the transmission apparatus 100 is connected to a plurality of playback apparatuses via a network 130, such as a LAN (Local Area Network), and the transmission apparatus 100 and the playback apparatus 150 perform communication with each other for video data playback, in accordance with a predetermined protocol. Note that a playback apparatus 1501 and the like have the same structure as the playback apparatus 150.

The transmission apparatus 100 includes a storage apparatus 101, an accumulation buffer unit 102, a transmission/reception unit 103 and a control unit 104, and the control unit 104 includes an accumulation buffer control subunit 105 and a user buffer control subunit 106.

The storage apparatus 101 is a video server composed of an HDD (hard disk drive), an optical storage apparatus, a magnetic tape apparatus or the like, and stores content, which is movies for user viewing, as video data compressed using a method such as MPEG-2 (Moving Picture Experts Group phase 2) or MPEG-4.

The accumulation buffer unit 102 is a readable/writable volatile memory that is logically divided into a plurality of buffers, and accumulates video data sequentially read from the storage apparatus 101 in accordance with the control unit 104.

The transmission/reception unit 103 is a communication circuit that connects the transmission apparatus 100 to the network, and transmits video data to the playback apparatus 150 as sequential stream data via the network. Also, the transmission/reception unit 103 receives, from the playback apparatus 150, control signals regarding transmission and reception of stream data, such as a video data transmission request or modification of a playback speed of the video data, and outputs the control signals to the control unit 104.

The control unit 104 includes a CPU (central processing unit), a ROM (read only memory) and a RAM (random access memory). Under control of a program stored in the ROM, the control unit 104 controls processing, such as processing related to reading video data from the storage apparatus 101 and storing the read video data in the accumulation buffer unit 102; transmitting, in accordance with a protocol such as RTP/RTCP (Real-time Transport Protocol/RTP Control Protocol) or RTSP (Real Time Streaming Protocol), the video data accumulated in the accumulation buffer unit 102 to the playback apparatus 150 as stream data; receiving a video data transmission request from the playback apparatus 150; determining an accumulation buffer to be assigned to a playback apparatus requesting video data; and aligning transmission positions of playback apparatuses within the same accumulation buffer.

The accumulation buffer control subunit 105 manages an accumulation buffer management table 200 which is described hereinafter, and based on this accumulation buffer management table 200, manages accumulation amounts of video data accumulated in the accumulation buffers resulting from the logical division, transmission positions of video data being transmitted to the playback apparatuses, and the like.

The user buffer control subunit 106 manages a user buffer management table 300 which is described hereinafter, and based on this user buffer management table 300, manages playback positions of video data being played back by the playback apparatuses, accumulation amounts of stream data accumulated in user buffers, playback speeds at which the video data is being played back by the playback apparatuses, and the like.

The playback apparatus 150 includes an STB (set top box) and a display for playing back the video data transmitted from the transmission apparatus 100. The playback apparatus 150 requests video data from the transmission apparatus 100 according to a user operation, receives the video data from the transmission apparatus 100 as stream data, and displays the video data on the display based on the received stream data to play back the video data.

A transmission/reception unit 151 of the playback apparatus 150 includes a communication circuit, and connects the playback apparatus 150 to the network 130 and receives stream data from the transmission apparatus 100.

An operation unit 152 is an input apparatus, such as a touch panel or remote control, and receives a user operation. The operation unit 152 receives user operations such as requesting transmission of video data, fast-forwarding video data during viewing, and slow-motion playback.

A user buffer 153 is a readable/writable volatile memory, and stores and accumulates stream data received via the transmission/reception unit 151.

A display unit 154 is a liquid crystal display that displays video data being played back.

A playback control unit 155 includes a CPU, a ROM and a RAM. In accordance with a program stored in the ROM, the playback control unit 155 controls processing regarding video data playback, such as processing related to requesting the transmission apparatus 100 to transmit video data; storing received stream data in the user buffer 153; communication processing related to conveying, in accordance with a predetermined protocol, a maximum amount of stream data that can be accumulated by the user buffer 153; and reading stream data from the user buffer 153 and performing display on the display unit 154.

Note that when making a video data transmission request to the transmission apparatus 100, the playback apparatus 150 specifies an absolute position on a time-axis of the video data, and makes the transmission request in accordance with the predetermined protocol. The predetermined protocol mentioned here is, for example, RTSP. As for the specification of an absolute position on the time-axis of the video data, specifying 145 to 148, in units of 1 second for example, would be a specification to transmit a portion of data from the 145th second to the 148th second of the video data.

At this time, the playback apparatus 150 transmits, in accordance with the predetermined protocol and at a predetermined interval, playback apparatus-related information such as the absolute position of video data accumulated in the user buffer 153, a playback position which shows a position in the video data at which the playback apparatus 150 is performing playback, and a playback speed of the video data, to the transmission apparatus 100 with, for example, the video data transmission request.

Also, when the transmission apparatus 100 receives the playback apparatus-related information from the playback apparatus 150, constituent elements of the user buffer management table 300 are updated by the user buffer control subunit 106.

Transmission positions 23 in the accumulation buffer management table 200 are also updated when requested video data is transmitted to playback apparatuses, and accumulation positions 22 and buffer numbers 21 in the accumulation buffer management table 200 are updated each time video data is read.

Data

Next is a description of the accumulation buffer management table 200 managed by the accumulation buffer control subunit 105 and the user buffer management table 300 managed by the user buffer control subunit 106.

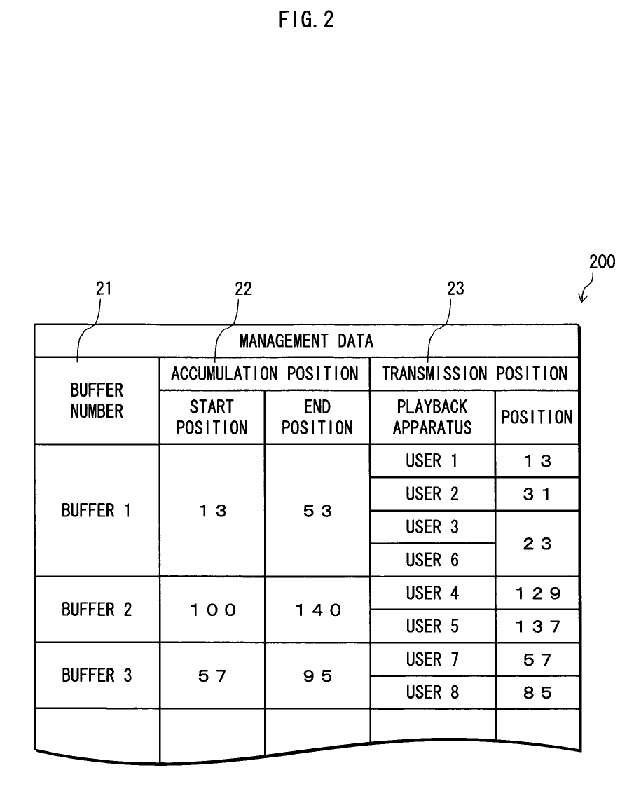

FIG. 2 shows a data structure of the accumulation buffer management table 200.

The structure of the accumulation buffer management table 200 includes pieces of management data which are associated with the accumulation buffers. Each piece of management data is constituted from a buffer number 21, an accumulation position 22 and at least one transmission position 23.

The buffer number 21 is a number for identifying a buffer which resulted from the logical division of the accumulation buffer unit 102.

The accumulation position 22 indicates an accumulation start position and an accumulation end position on a time-axis, pertaining to accumulated video data read from the storage apparatus 101.

Note that start positions and end positions are shown in units of, for example, 1 second. Taking an example from the figure, a start position value of “13” and an end value of “53” are stored in the accumulation position 22 of user 1, which shows that a portion of video data from the 13th second to the 53rd second has been read from the storage apparatus 101 and is stored.

The transmission positions 23 indicate, for each playback apparatus to which stream data is being transmitted, which portions on the time-axis of the video data accumulated in the corresponding buffer are being transmitted.

Taking an example from the figure, it is shown that data at a position after the 13th second of video data is being transmitted to the user 1 which is using a buffer 1, and data at a position after the 23rd second of video data is being transmitted to users 3 and 6. Note that user 1 and user 3 are names for identifying playback apparatuses.

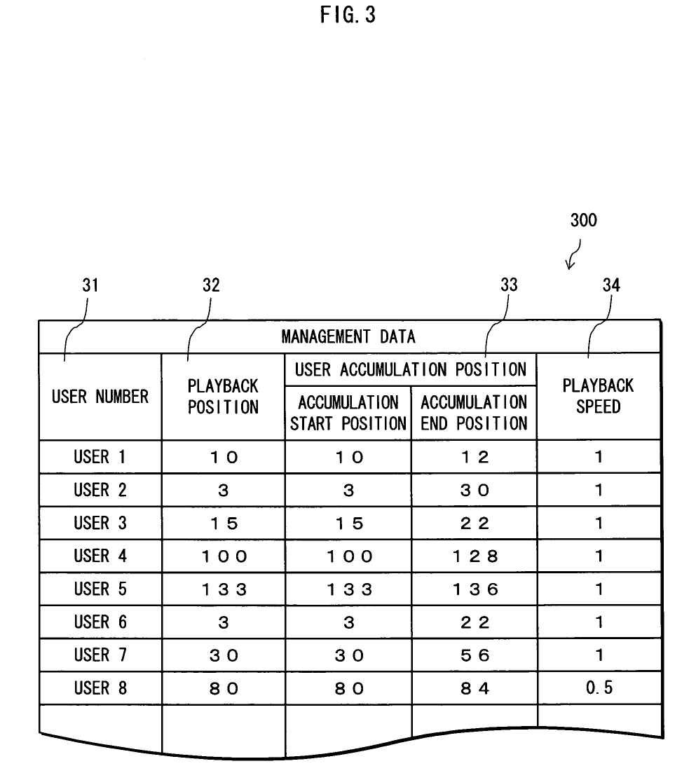

FIG. 3 shows a data structure of the user buffer management table 300.

The structure of the user buffer management table 300 includes user numbers 31, playback positions 32, user accumulation positions 33 and playback speeds 34.

A user number 31 is an identifier for identifying a corresponding playback apparatus.

A playback position 32 indicates which portion on the time-axis of the video data is being played back by a playback apparatus corresponding to a user number.

Taking an example from the figure, the playback position 32 of the user 1 shows “10”, which indicates that the user 1 is playing back a portion of data 10 seconds from the beginning of the video data.

A user accumulation position 33 indicates an absolute position on the time-axis of the video data, pertaining to stream data that a user buffer of a playback apparatus received from the transmission apparatus 100, and indicates an accumulation start position and an accumulation end position of the video data accumulated in the corresponding user buffer 153.

Taking an example from the same figure, a value of “10” is indicated in the user accumulation position 33 of the user 1, and a value of “12” is indicated in the accumulation end position, thereby indicating that a portion of the video data from the 10th second to the 12th second is accumulated in the user buffer 153 of the user 1.

A playback speed 34 indicates a speed at which the corresponding playback apparatus is playing back the video data. By communicating with the transmission apparatus 100 in accordance with a protocol such as RTSP, the playback apparatus 150 can perform slow-motion playback, which is playback at a speed slower than normal viewing, and double-speed playback, which is playback at 2× speed. The speed of normal playback is set to “1” in the playback speed 34, and speed differences relative to the normal playback speed are shown as “2” when playing back at double speed, and as “0.5” when playing back at half the normal speed.

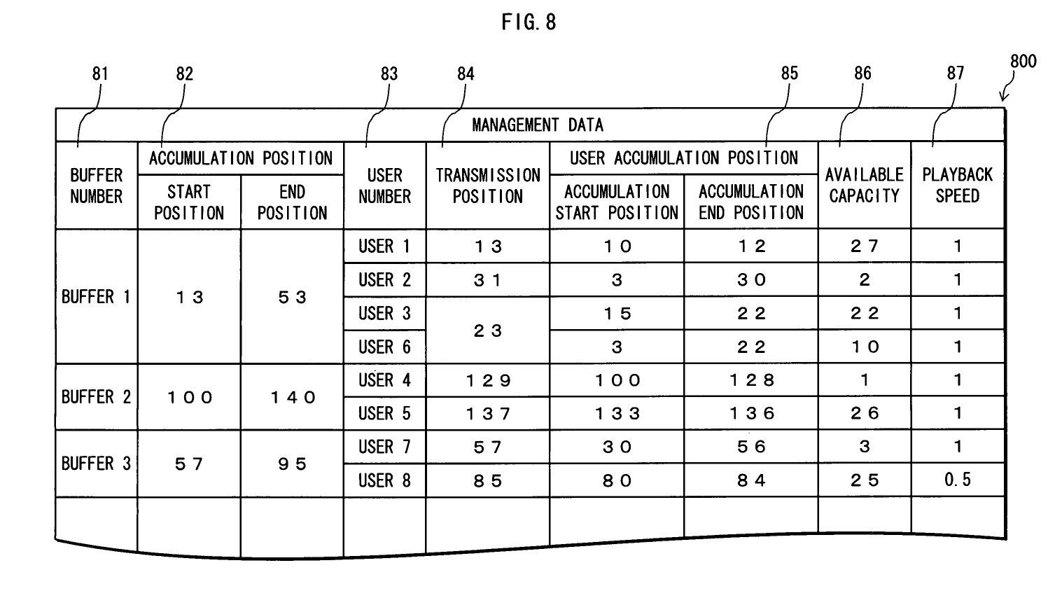

FIG. 8 shows a data structure of a transmission position management table 800.

The transmission position management table 800 is obtained based on the accumulation buffer management table 200 and the user buffer management table 300, and its structure includes pieces of management data. As shown in the figure, the transmission position management table 800 includes buffer numbers 81, accumulation positions 82, user numbers 83, transmission positions 84, user accumulation positions 85, available capacities 86 and playback speeds 87.

The buffer numbers 81, the accumulation positions 82 and the transmission positions 84 show the same content as the buffer numbers 21, the accumulation positions 22 and the transmission positions 23 indicated in FIG. 2, and the user numbers 83, the user accumulation positions 85 and the playback speeds 87 show the same content as the user numbers 31, the user accumulation positions 33 and the playback speeds 34 indicated in FIG. 3, and descriptions thereof are therefore omitted.

An available capacity 86 indicates an available area on a corresponding user buffer 153 which can be used for accumulation of the stream data. A maximum amount of stream data that the user buffer 153 can accumulate is predetermined as, for example, 30 seconds-worth of stream data. The available capacity 86 indicates an amount corresponding to a difference between the maximum amount of data that the user buffer 153 can accumulate and the amount of stream data currently accumulated.

Taking an example from FIG. 8, the user number 83 “user 1”, which is one of the playback apparatuses using the buffer 1, can accumulate 30 seconds-worth of stream data, and the user accumulation position 85 indicates that a portion from the 10th second to the 12th second of the video data, which is a total of 3 seconds-worth of stream data, is accumulated in the user buffer 153. Given that the maximum amount of stream data that can be accumulated is 30 seconds, and 3 seconds-worth of stream data is accumulated, the available area is the difference of 27 seconds-worth, whereby a value of “27” indicating the difference is shown in the corresponding available capacity 86.

Note that the maximum amount of stream data that can be accumulated in the user buffer 153 of the playback apparatus is conveyed in accordance with a predetermined protocol when the playback apparatus 150 starts communication with the transmission apparatus 100. Also, given that the transmission position management table 800 is obtained based on the accumulation buffer management table 200 and the user buffer management table 300, constituent elements of the transmission position management table 800 are updated along with an update to the accumulation buffer management table 200 and the user buffer management table 300.

Operations

The following describes the transmission apparatus 100 having the above-mentioned structure.

Upon new receipt of a video data transmission request from the playback apparatus 150, the control unit 104 of the transmission apparatus 100 determines an accumulation buffer to be assigned to the playback apparatus that has requested video data.

If a plurality of playback apparatuses are using the same accumulation buffer, the control unit 104 references the accumulation buffer management table 200 managed by the accumulation buffer control subunit 105, and controls data transmission amounts to the playback apparatuses so as to align their transmission positions.

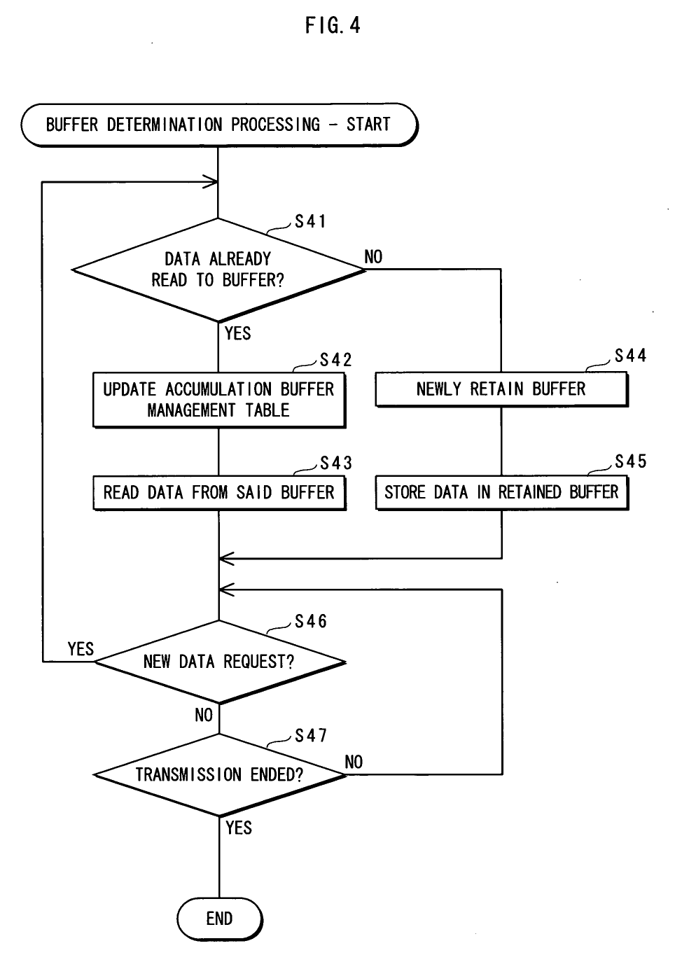

FIG. 4 is a flowchart showing processing performed by the control unit 104 to determine accumulation buffers to be assigned to the playback apparatuses.

Upon receipt of a data transmission request from a playback apparatus, the control unit 104 references the accumulation positions 22 of the accumulation buffer management table 200, and judges whether video data at the position requested by the playback apparatus has already been read to an accumulation buffer assigned to another playback apparatus (S41).

If the video data at the position requested by the playback apparatus has already been read to the accumulation buffer assigned to the other playback apparatus (S41:YES), the control unit 104 assigns this accumulation buffer to the playback apparatus that made the video data transmission request, and causes the accumulation buffer control subunit 105 to update the accumulation buffer management table 200 (S42).

After the accumulation buffer management table 200 has been updated by the accumulation buffer control subunit 105, the control unit 104 reads the video data from the accumulation buffer and transmits stream data to the playback apparatus, in accordance with the updated accumulation buffer management table 200 (S43).

If the video data requested by the playback apparatus 150 has not yet been read to any accumulation buffer in step S41 (S41:NO), the control unit 104 newly retains an accumulation buffer in the accumulation buffer unit 102 for transmission of stream data to the playback apparatus (S44).

The control unit 104 reads the video data at the position requested by the playback apparatus from the storage unit 101, and stores the read video data in the newly retained accumulation buffer, then successively reads the video data from the newly retained accumulation buffer and transmits stream data to the playback apparatus (S45).

Each time a fast forward or the like results in a transmission request for video data at a position that has not been read to an accumulation buffer, or each time there is a new video data transmission request from another playback apparatus (S46:YES), the control unit 104 repeats processing to determine accumulation buffers to be assigned to playback apparatuses, until the playback apparatus ends making video data transmission requests (S47:YES).

In this way, when a plurality of playback apparatuses come to use the same accumulation buffer, the control unit 104 performs aggregation processing to align, within the accumulation buffer, the transmission positions of stream data being transmitted to the playback apparatuses, while referencing the accumulation buffer management table 200 and the user buffer management table 300.

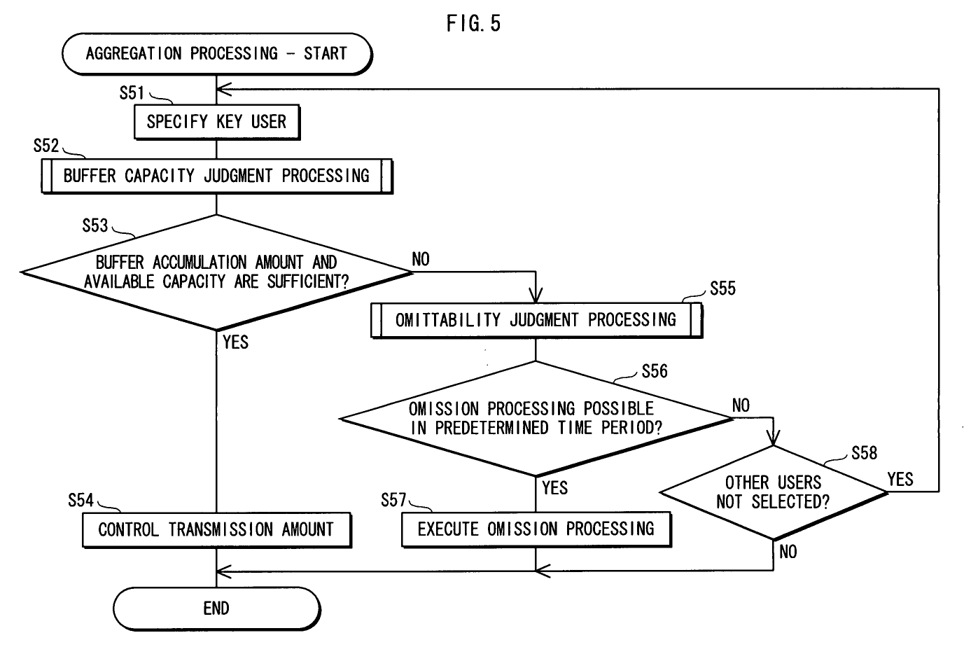

FIG. 5 is a flowchart showing aggregation processing performed by the control unit 104 to align, in an accumulation buffer, transmission positions of stream data being transmitted to a plurality of playback apparatuses.

When a plurality of playback apparatuses are using the same accumulation buffer, the control unit 104 specifies a certain playback apparatus as a target to which transmission positions will be aligned, and makes the specified playback apparatus a key user (S51). Also, the control unit 104 specifies a playback apparatus whose transmission position is to be aligned with the transmission position of the key user as an adjustment user.

Upon specifying the key user (S51), the control unit 104 references the available capacities 86, the user accumulation positions 85, the transmission positions 84, etc., which are in the transmission position management table 800 shown in FIG. 8, of the key user and the adjustment user, and judges whether the user accumulation position 85 and the available capacity 86 of each playback apparatus are sufficient in order to align the transmission positions 84 (S52).

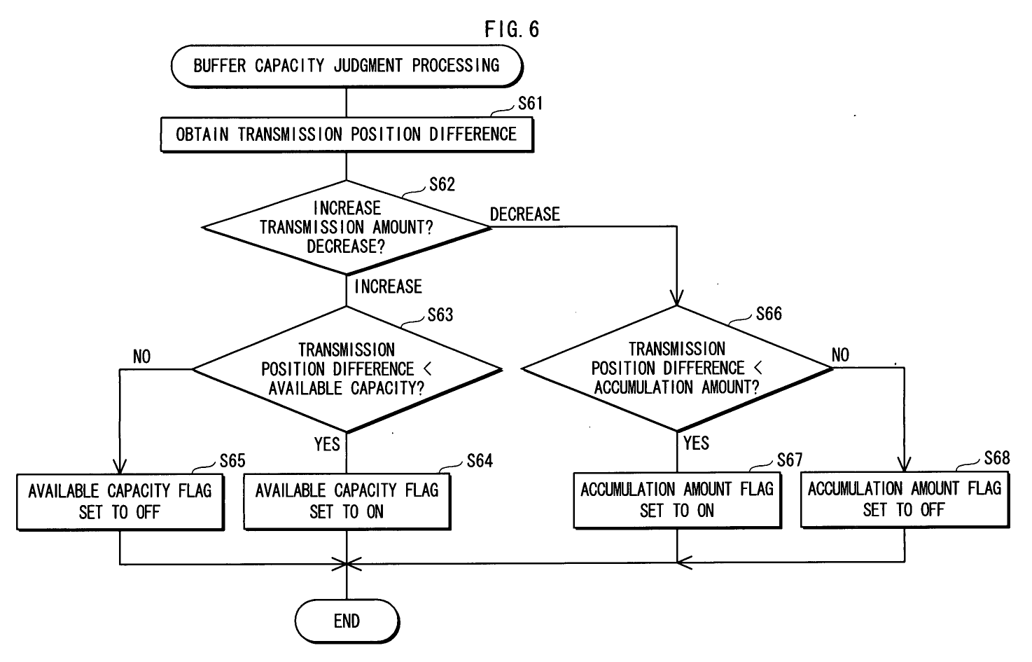

The following describes step S52, with reference to FIG. 6.

FIG. 6 is a flowchart showing buffer capacity judgment processing.

The control unit 104 references the transmission positions 84 to obtain a stream data transmission amount which corresponds to a difference between the transmission positions of the adjustment user and the key user, and makes the obtained difference a transmission position difference (S61).

Here, the control unit 104 judges whether to increase or decrease the amount of stream data transmitted to the adjustment user within a predetermined time period, to make this transmission amount greater than or less than the transmission amount necessary for viewing the video data at normal playback speed (S62). In the case of increasing the transmission amount for alignment with the transmission position of the key user (S62:INCREASE), the control unit 104 references the available capacity 86 of the adjustment user, and judges whether the value indicated in the available capacity 86 is greater than the transmission position difference (S63).

If the value indicated by the available capacity 86 is greater than the transmission position difference (S63:YES), the control unit 104 judges the available capacity 86 to be sufficient, and sets an available capacity flag to ON which indicates that the buffer available capacity is sufficient (S64). If the value indicated by the available capacity 86 is less than the transmission position difference in step S63 (S63:NO), the control unit 104 judges the available capacity 86 to be insufficient, and sets the available capacity flag to OFF (S65).

Note that the available capacity flag is expressed by, for example, one bit, whereby the available capacity flag is set to ON when “1” is indicated, and is set to OFF when “0” is indicated.

In the case of performing alignment with the transmission position of the key user in step S62 by decreasing the amount of data transmitted to the adjustment user so as to be less than the transmission amount necessary for viewing of the video data at normal playback speed (S62:DECREASE), the control unit 104 compares the transmission position difference and the amount of stream data accumulated in the user buffer 153 of the adjustment user (S66). If the amount of stream data accumulated in the user buffer 153 is greater than the transmission position difference (S66:YES), the control unit 104 judges that the amount of stream data accumulated in the user buffer 153 of the adjustment user is sufficient, and sets an accumulation amount flag to ON which indicates that the accumulated amount of stream data is sufficient (S67).

If the amount of stream data accumulated in the user buffer 153 is less than the transmission position difference in step S66 (S66:NO), the control unit 104 judges that the amount of stream data accumulated in the user buffer 153 of the adjustment user is insufficient, and sets the accumulation amount flag to OFF (S68).

If the buffer available capacity or the amount of stream data accumulated in the user buffer 153 of the adjustment user is judged to be sufficient, and the availability flag or the accumulation amount flag is set to ON in step S52 (S53:YES), the control unit 104 controls the amount of stream data transmitted to the adjustment user within the predetermined time period to align this transmission amount with the transmission amount of the key user (S54).

Taking an example from FIG. 8, the control unit 104 specifies a user 3 which is using the buffer 1 as the key user, and makes the user 1 the adjustment user. Given that the transmission position 84 of the user 1 is “13”, and that the transmission position 84 of the user 3 is “23”, the transmission positions of the user 1 and the user 3 can be aligned by transmitting 10 more seconds-worth of stream data, which corresponds to the transmission position difference, to the user 1, compared to the amount of stream data transmitted to the user 3.

Here, upon referencing the available capacity 86 of the user 1, which is the adjustment user, and finding that the available capacity 86 is “27”, which is greater than the transmission position difference, the control unit 104 judges that the available capacity 86 of the user 1 is sufficient, and sets the available capacity flag to ON.

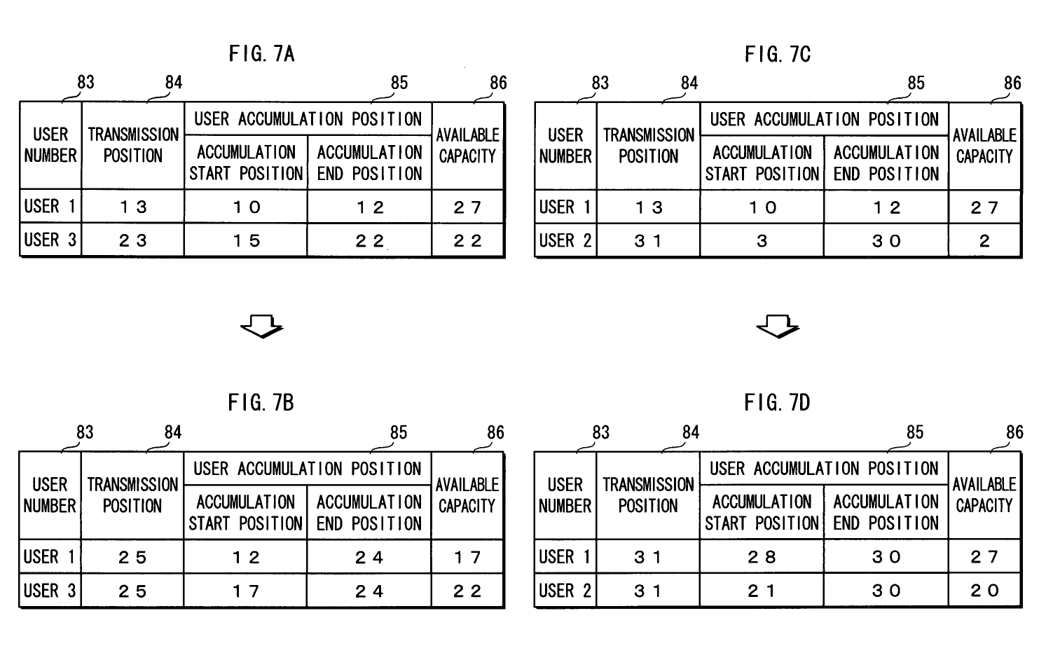

Upon enabling the available capacity flag, the control unit 104 transmits 10 more seconds-worth of stream data, which corresponds to the transmission position difference, to the user 1 compared to the user 3. FIGS. 7A to 7D show transition states of aligning transmission positions of stream data being transmitted to playback apparatuses. As shown in FIGS. 7A to 7D, transmission positions of stream data being transmitted to the playback apparatuses transition from the state shown in FIG. 7A to the state shown in FIG. 7B of the same figure. The transmission positions of the users 1 and 3 differ in FIG. 7A, but are aligned by increasing the amount of stream data transmitted to the user 1, which is the adjustment user, so as to be more than the amount transmitted to the user 3, which is the key user.

Taking the example of specifying the user 1 as the key user and making the user 2 the adjustment user, stream data from the 3rd second to the 30th second is accumulated in the user buffer 153 of the user 2, whereby 28 seconds-worth of stream data is accumulated. On the other hand, the transmission position 84 of the user 1 indicates “13”, whereby 18 seconds-worth of stream data corresponds to the transmission position difference with the user 2.

Given that the amount of stream data accumulated in the user buffer 153 of the user 2 is greater than the transmission position difference, the control unit 104 judges the buffer accumulation amount of the user 2, which is the adjustment user, to be sufficient, and sets the accumulation amount flag to ON.

When the accumulation amount flag is set to ON, the control unit 104 decreases the amount of stream data transmitted to the user 2 in the predetermined time period, so as to be less than the amount transmitted to the user 1.

As shown in FIGS. 7A to 7D, the transmission positions of stream data being transmitted to the playback apparatuses transition from the state shown in FIG. 7C to the state shown in FIG. 7D. The transmission positions of the users 1 and 2 differ in FIG. 7C, but are aligned by decreasing the amount of stream data transmitted in the predetermined time period to the user 2, which is the adjustment user, so as to be less than the amount transmitted to the user 1.

If the user buffer accumulation amount of the adjustment user or the buffer available capacity is judged to be insufficient, and the available capacity flag or the accumulation amount flag is set to OFF in step S52 (S53:NO), the control unit 104 judges whether it is possible to align the transmission position of the adjustment user with the transmission position of the key user by performing omission processing that omits a part of the stream data to be transmitted to the adjustment user within the predetermined time period (S55).

As shown in the specific example of a user 4 and a user which are using a buffer 2 in FIG. 8, the transmission position difference, which is the difference between the transmission position 84 of the user 4 and the transmission position 84 of the user 5, is “8”, and the available capacity 86 of the user 4 is “1”, whereby it is not possible to align the transmission positions of the users 4 and 5 by increasing the amount of data transmitted to the user 4.

Also, the transmission positions of the users 4 and 5 cannot be aligned even if the amount of data transmitted to the user 5 is decreased, due to the fact that the amount of stream data stored in the user buffer of the user 5 is only 4 seconds-worth from the 133th second to the 136th second (S53:NO).

In this case, the control unit 104 judges whether it is possible to align the transmission positions of the playback apparatuses by omitting a part of the stream data to be transmitted to the adjustment user in the predetermined time period (S55). For example, the control unit 104 makes the user 4 the adjustment user and specifies the user 5 as the key user, and judges whether the transmission position of the user 4 can be aligned with the user 5 by omitting a part of the stream data to be transmitted to the user 4 in the predetermined time period.

Here, omitting a part of stream data refers to transmitting, to the adjustment user, stream data from which a part has been omitted.

For example, assuming that the stream data is constituted from 30 frames per second, 1 frame out of the 30 frames is omitted, thereby meaning that stream data is now constituted from 29 frames per second. Note that the amount of stream data assumed to be transmitted in 1 second is assumed to be 30 frames-worth of stream data.

Consequently, assuming 1 frame out of the 30 frames constituting 1 second of stream data is omitted, thereby making 1 second of stream data be constituted from 29 frames, and assuming that 30 frames-worth of stream data is transmitted in 1 second, 1 second of stream data transmission can transmit 29 frames+1 frame, that is, stream data constituting 1 second plus an additional 1 frame-worth of stream data can be transmitted.

For example, assuming 30 frames are transmitted per 1 second of stream data transmission, after 29 seconds, 30 frames×29 seconds=870 frames of stream data will be transmitted.

Here, if no part of the stream data is omitted, and stream data is constituted from 30 frames per second, after 29 seconds, 870 frames+(30 frames per second)=29 seconds-worth of stream data will have been transmitted.

On the other hand, if a part of the stream data is omitted, whereby the stream data is made to be constituted from 29 frames per second by omitting 1 frame from the 30 frames, after 29 seconds, 870 frames+(29 frames per second)=30 seconds-worth of stream data will have been transmitted.

As in the above-mentioned example, omitting a part of the stream data in this way enables the stream data transmission positions of the adjustment user and the key user to become 1 second closer after 29 seconds have passed.

Note that a part of the stream data is omitted such that a user viewing the stream data will not be able to perceive that a part of the stream data has been omitted. For example, omission is performed by omitting 1 frame out of 30 frames, as was mentioned above.

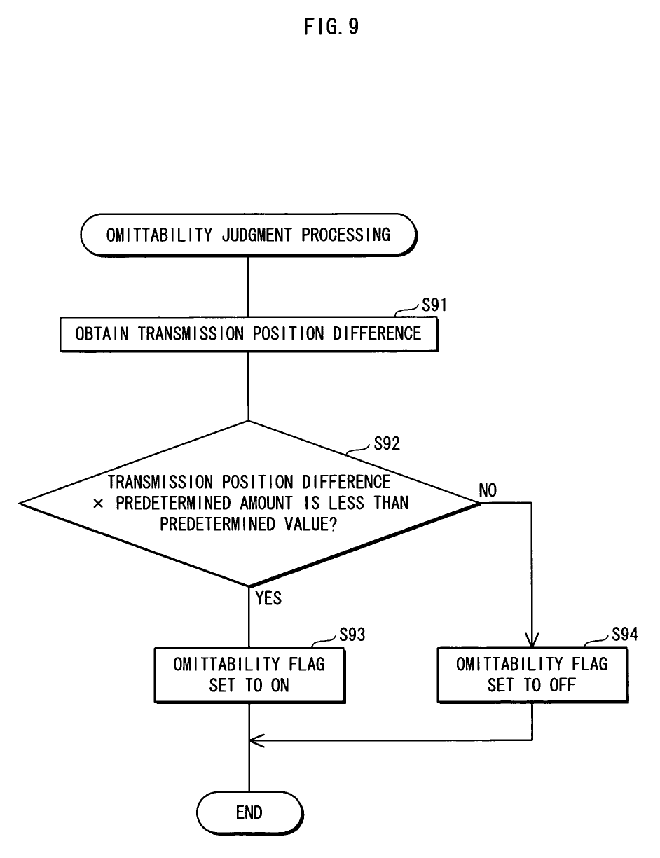

The following describes, using FIG. 9, processing performed by the control unit 104 in step S55 to judge whether it is possible to align the transmission position of the adjustment user with the transmission position of the key user by omitting a part of the stream data to be transmitted to the adjustment user in the predetermined time period.

FIG. 9 is a flowchart showing omittability-judgment processing pertaining to judging whether it is possible to align the transmission positions of playback apparatuses by omitting a part of the stream data to be transmitted to the adjustment user in the predetermined time period.

The control unit 104 obtains the transmission position difference which is the stream data transmission amount corresponding to the difference between the transmission positions of the adjustment user and the key user (S91), and judges whether a product of the obtained transmission position difference and a predetermined amount is smaller than a predetermined value (S92).

If the product of the transmission position difference and the predetermined amount is smaller than the predetermined value (S92:YES), the control unit 104 sets an omittability flag to ON which indicates that it is possible to align the transmission positions of the adjustment user and the key user by performing omission processing (S93).

If the product of the transmission position difference and the predetermined amount is not smaller than the predetermined value in step S92 (S92:NO), the control unit 104 judges that it is not possible to align the transmission positions of the adjustment user and the key user even if omission processing is performed, and sets the omittability flag to OFF (S94).

The following describes a configuration method for the predetermined amount and the predetermined value in step S92. The predetermined amount is made the time period required for bringing the stream data transmission position of one playback apparatus 1 second closer to the transmission position of another playback apparatus by, for example, transmitting stream data from which a part has been omitted. For example, taking the exemplary case of omitting 1 frame from stream data constituted from 30 frames per second as mentioned above, the predetermined amount is set to 29 since it is possible to omit a part of the stream data transmitted to the adjustment user and become 1 second closer to the transmission position of the key user after 29 seconds have passed from the start of transmission. Also, the predetermined value is set to be a remaining playback time which is a time period from a position at which the playback apparatus is currently playing back video data until the playback ends.

Taking an example of the users 4 and 5 in FIG. 8, the transmission position 84 of the user 4 is “129”, and the transmission position 84 of the user 5 is “137”. Consequently, the transmission position difference is 8 seconds-worth of stream data. The video data remaining playback time is 2900 seconds, and as mentioned above, the predetermined amount is 29. Given that the transmission position difference (8)×the predetermined amount (29) is smaller than the predetermined value (the remaining playback back, which is 2900), the control unit 104 sets the omittability flag to ON.

If the control unit 104 judges that the transmission positions of users can be aligned, and sets the omittability flag to ON in step S55 (S56:YES), the control unit 104 aligns the transmission position of the adjustment user with the transmission position of the key user by performing omission processing to omit a part of the stream data to be transmitted to the adjustment user (S57).

If the control unit 104 judges that the transmission positions of user cannot be aligned and sets the omittability flag to OFF in step S55 (S56:NO), the control unit 104 does not perform omission processing. The control unit 104 judges whether there is another playback apparatus which has not been selected as the key user (S58), and, if there is another playback apparatus which has not been selected as the key user (S58:YES), newly specifies a key user (S51), and performs processing to aggregate the transmission positions. If there is not another playback apparatus which has not been selected as the key user in step S58 (S58:NO), the control unit 104 ends processing to aggregate the transmission positions.

In this way, the control unit 104 performs aggregation processing to align, within an accumulation buffer, the transmission positions of stream data being transmitted to playback apparatuses.

### Embodiment 2

The following describes embodiment 2 pertaining to the present invention.

In embodiment 2, if video data requested by a playback apparatus is already accumulated in a user buffer of another playback apparatus, the video data is second-generation distributed from the playback apparatus having the video data accumulated to the playback apparatus requesting the video data, and transmission positions of video data sent to each of the playback apparatus are aligned by aligning positions of the video data that is accumulated in user buffers of playback apparatuses by second generation distribution.

Next is a description with principal focus on points that differ from embodiment 1.

Structure

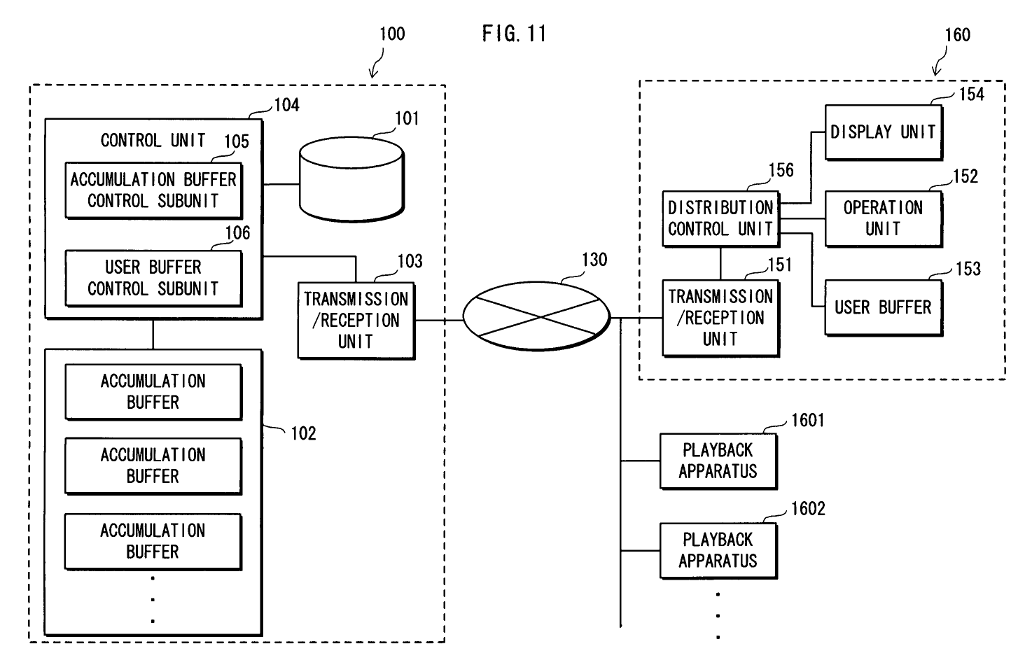

FIG. 11 is a functional block diagram showing a structure of a transmission apparatus 100 and a playback apparatus 160 pertaining to embodiment 2.

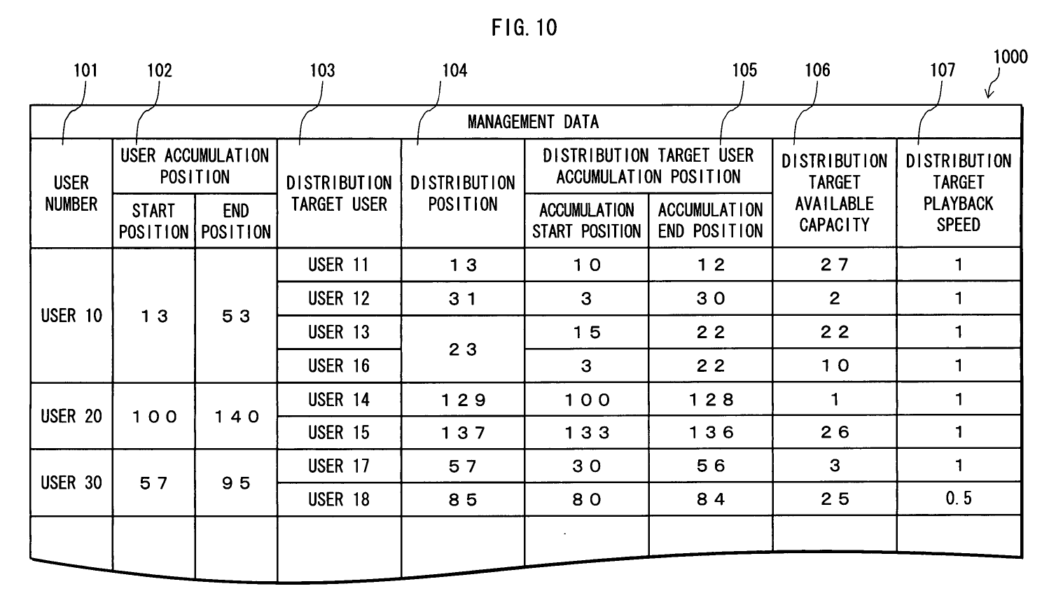

A user buffer control subunit 106 of the transmission apparatus 100 pertaining to embodiment 2 manages a second generation distribution management table 1000 shown in FIG. 10, and manages, based on the second generation distribution management table 1000, an amount of stream data accumulated in user buffers 153 of playback apparatuses, distribution target users, and the like.

A control unit 104 of the transmission apparatus 100 transmits, in accordance with a predetermined protocol, a control signal such that playback apparatuses perform second generation distribution based on the second generation distribution management table 1000.

The playback apparatus 160 pertaining to embodiment 2 can perform second generation distribution which transmits video data, which was received from the transmission apparatus 100 and accumulated in a user buffer 153, to another playback apparatus based on a control signal received from the transmission apparatus 100.

A distribution control unit 156 of the playback apparatus 160 includes a CPU, a ROM and a RAM, and controls, in accordance with a program stored in the ROM, processing such as distributing video data accumulated in a user buffer 153 to another playback apparatus. Note that a playback apparatus 1601 and the like have the same structure as the playback apparatus 160.

Also, the playback apparatus 160 second-generation distributes video data upon receipt, from the transmission apparatus 100, of a control signal pertaining to the second generation distribution of the video data. Upon starting the second generation distribution, the playback apparatus 160 transmits, in accordance with the predetermined protocol, distribution position information, which shows a position in the video data read from the user buffer 153 at which distribution is performed, to the transmission apparatus 100 each time second generation distribution is performed.

Also, the transmission apparatus 100 updates a distribution target user 103 and a distribution position 104 of the second generation distribution management table 1000 upon each receipt of distribution position information from the playback apparatus 160. Note that among constituent elements of the second generation distribution management table 1000, user accumulation positions 102, distribution target user accumulation positions 105, distribution target available capacities 106 and distribution target playback speeds 107 are updated along with an update of the user buffer management table 300.

Data

Next is a description of the second generation distribution management table 1000 using FIG. 10.

FIG. 10 shows a data structure of the second generation distribution management table 1000.

The second generation distribution management table 1000 is constituted from user numbers 101, user accumulation positions 102, distribution target users 103, distribution positions 104, distribution target user accumulation positions 105, distribution target available capacities 106 and distribution target playback speeds 107.

The user numbers 101 are identifiers for identifying playback apparatuses performing second generation distribution of stream data.

The user accumulation positions 102 indicate accumulation start positions and accumulation end positions on a time-axis, pertaining to video data accumulated in user buffers 153 of the playback apparatuses performing second generation distribution.

The distribution target users 103 indicate distribution target playback apparatuses to which the video data stored in the user buffers 153 is being distributed.

The distribution positions 104 indicate, for each second generation distribution target playback apparatus, which portion on a time-axis of the video data accumulated in the user buffer 153 of the playback apparatus performing second generation distribution is being distributed.

The distribution target user accumulation positions 105 indicate accumulation start positions and accumulation end positions on the time-axis of the video data accumulated by the distribution target playback apparatuses.

The distribution target available capacities 106 indicate available areas of user buffers 153, which can be used by the distribution target playback apparatuses for accumulation of stream data.

The distribution target playback speeds 97 indicate speeds at which the video data is being played back by the distribution target playback apparatuses.

Operations

Next is a description of the transmission apparatus 100 having the above-mentioned structure.

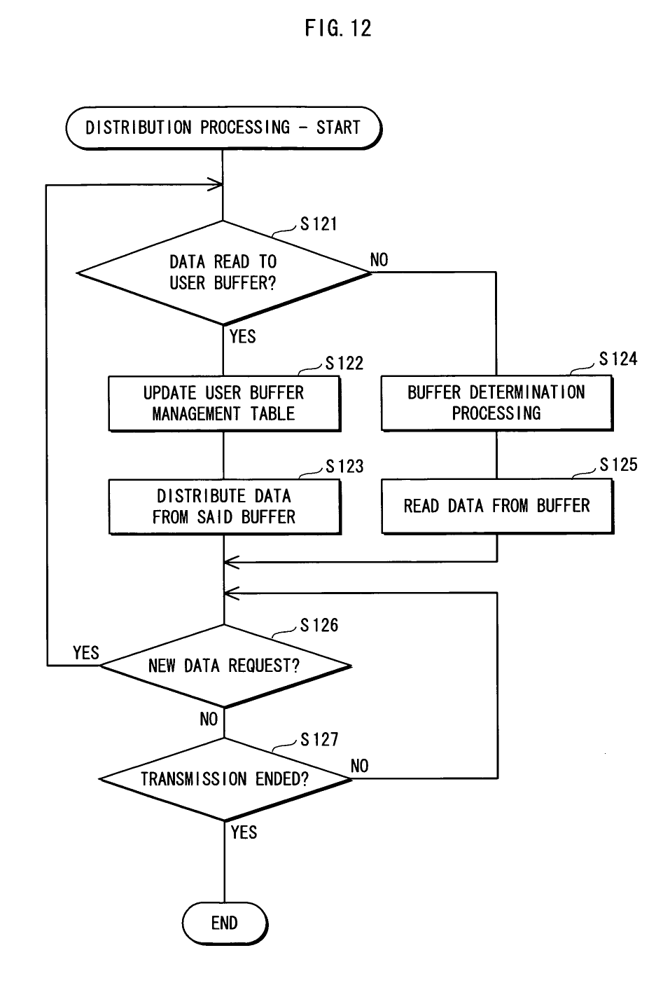

FIG. 12 is a flowchart showing processing performed by the control unit 104 of the transmission apparatus 100 to cause a playback apparatus to perform second generation distribution.

Upon new receipt of a video data transmission request from the playback apparatus 160, the control unit 104 references the user accumulation positions 102 of the second generation distribution management table 1000, and judges whether the requested video data has already been accumulated in the user buffer 153 of another playback apparatus (S121).

If the video data has already been accumulated to the user buffer 153 of another playback apparatus (S121:YES), the control unit 104 updates the second generation distribution management table 1000 (S122), transmits a control signal so as to cause the playback apparatus in which the video has already been accumulated to perform second generation distribution, and causes the playback apparatus to execute second generation distribution (S123).

If the video data requested by a playback apparatus is not accumulated in the user buffer 153 of another playback apparatus in step S121 (S121:NO), similarly to as in embodiment 1, the control unit 104 performs processing to assign an accumulation buffer of the transmission apparatus 100 (S124), reads video data from this accumulation buffer, and transmits the read video data to the playback apparatus (S125).

Each time a fast forward or the like results in a transmission request for video data at a position that has not been accumulated in the user buffer of a user performing second generation distribution, or each time there is a new video data transmission request from another playback apparatus (S126:YES), the control unit 104 repeats processing to cause a playback apparatus already having the video data accumulated to perform second generation distribution, until the playback apparatus ends making video data transmission requests (S127:YES).

In this way, the playback apparatus 150 performs second generation distribution, under control of the transmission apparatus 100, to distribute video data accumulated in user buffers 153 of playback apparatuses to other playback apparatuses.

Note that aggregation processing to align transmission positions within a user buffer is performed even in the case of causing a playback apparatus to second-generation distribute video data, such as the example of the user buffer of user 10 in FIG. 10, in which second generation distribution to a plurality of playback apparatuses from the same user buffer is performed. A description of aggregation processing to align, within a user buffer, the transmission positions of stream data being distributed to playback apparatuses is omitted since this processing is similar to the processing to align, within a user buffer, transmission positions of stream data being transmitted to playback apparatuses, as described in embodiment 1.

As described above, transmission positions of video data being transmitted to playback apparatuses can be aligned by performing aggregation of the transmission positions as well as performing second generation distribution, whereafter the transmission apparatus 100 can transmit stream data at the same transmission position to each of the playback apparatuses.

### Embodiment 3

The following describes embodiment 3 pertaining to the present invention.

If stream data is being transmitted to a plurality of playback apparatuses, and a stream data transfer request is newly received from another playback apparatus, the transmission apparatus of embodiment 3 judges whether a bandwidth of the communication route between the transmission apparatus and the playback apparatuses is sufficient for transmission of stream data to the playback apparatuses. If the bandwidth of the communication route is judged to be insufficient, the transmission apparatus converts stream data such that the stream data can be transmitted to the playback apparatuses, and transmits the converted stream data.

Once transmission positions of the stream data being transmitted to the playback apparatuses have been controlled such that the transmission positions are aligned, as described in embodiment 1, the transmission apparatus then ends conversion processing of the stream data, and thereafter transmits unconverted stream data to the playback apparatuses.

Next is a description with principal focus on points that differ from embodiment 1.

Structure

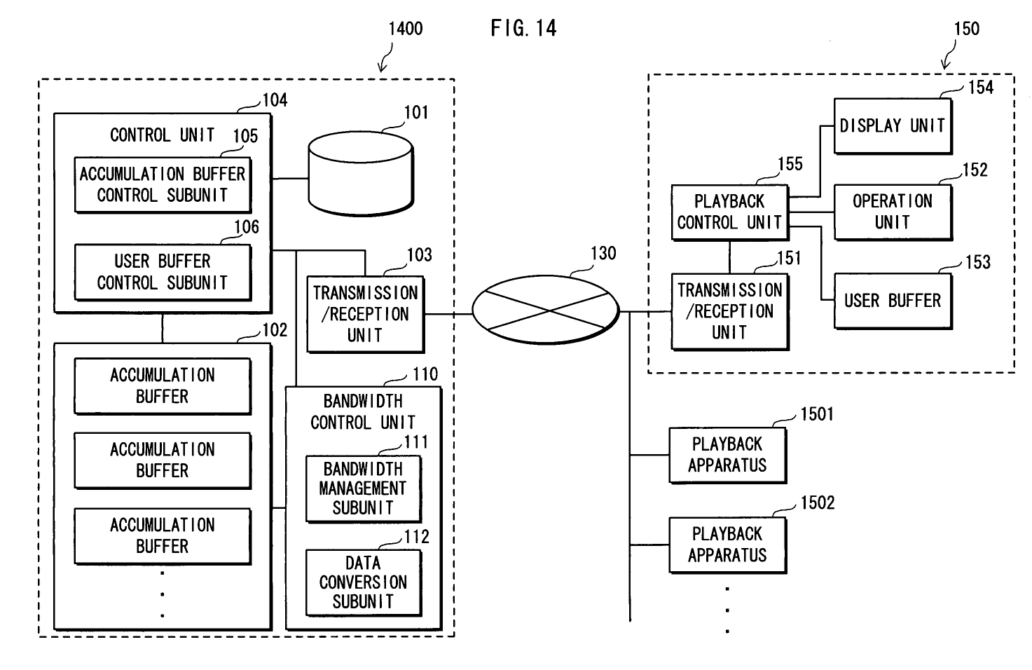

FIG. 14 is a functional block diagram showing a structure of a transmission apparatus 1400 and a playback apparatus 150 pertaining to embodiment 3. Note that constituent elements which are the same as those of the transmission apparatus 100 of embodiment 1, such as the storage apparatus 101 and the transmission/reception unit 103, have been given the same reference characters, and their descriptions have therefore been omitted.

As shown in the figure, the transmission apparatus 1400 includes a bandwidth control unit 110. The bandwidth control unit 110 includes a bandwidth management subunit 111 and a data conversion subunit 112.

The bandwidth control unit 110 manages bandwidth of the communication route, and controls, according to a bandwidth that is being used, processing related to data conversion of stream data to be transmitted to a playback apparatus.

The bandwidth management subunit 111 manages a bandwidth management table 1900 which is mentioned hereinafter, receives an instruction from the control unit 104, and references a used bandwidth of the communication route in order to judge whether it is necessary to perform data conversion on stream data to be transmitted.

In accordance with control of the bandwidth management subunit 111, the data conversion subunit 112 performs data conversion processing with respect to stream data to be transmitted, such as re-encode processing to convert video data recorded in the MPEG-2 format to the MPEG-4 format, and processing to convert a bitrate of video data recorded in the MPEG-2 format.

Upon aligning transmission positions of the stream data transmitted to the playback apparatuses, the accumulation buffer control subunit 105 of the control unit 104 outputs, to the bandwidth control unit 110, information indicating the alignment.

Data

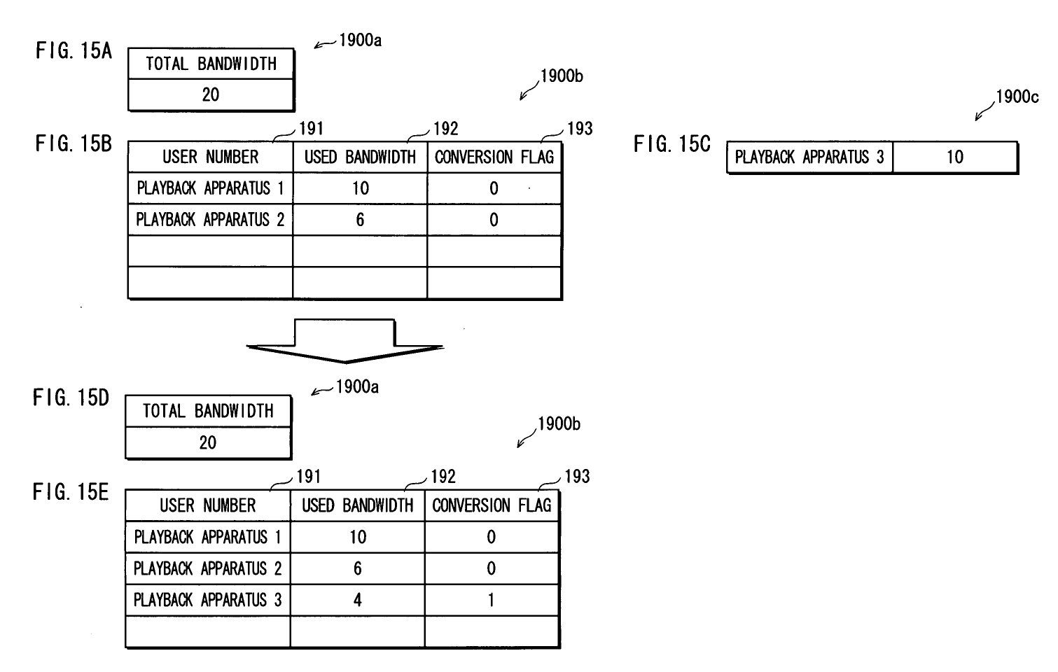

FIGS. 15A and 15B show the bandwidth management table 1900 managed by the bandwidth management subunit 111.

As shown in the figure, the bandwidth management table 1900 is composed of a total bandwidth 1900a indicating a total bandwidth of the communication route, and a playback apparatus management table 1900b managing playback apparatuses to which stream data is being transmitted.

As mentioned above, the total bandwidth 1900a indicates the total bandwidth of the communication route. Taking an example from the figure, the total bandwidth 1900a indicates “20”, which shows that the total bandwidth of the communication route is 20 Mbps.

Each record of the playback apparatus management table 1900b includes a user number 191, a used bandwidth 192 and a conversion flag 193.

The user number 191 is an identifier for identifying a playback apparatus.

The used bandwidth 192 indicates how much bandwidth of the communication route is occupied by stream data being transmitted to a corresponding playback apparatus.

The conversion flag 193 indicates whether conversion is being performed on stream data being transmitted to the corresponding playback apparatus. Whether or not conversion is being performed is indicated by whether the value indicated by the conversion flag 193 is “0” or “1”, whereby “0” indicates that conversion is not being performed, and “1” indicates that conversion is being performed.

Operations

Next is a description of operations of the transmission apparatus 1400.

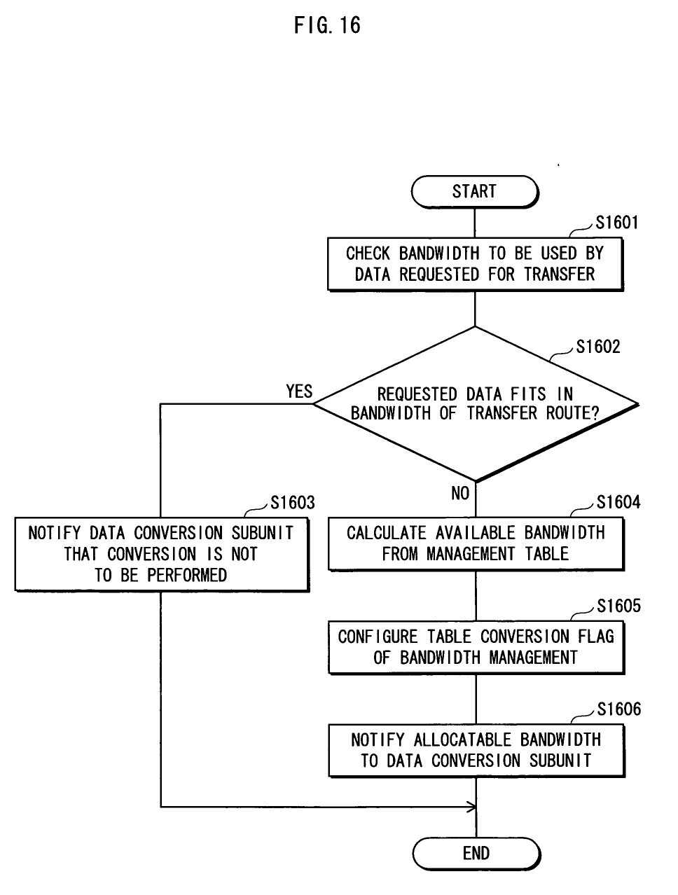

FIG. 16 is a flowchart showing processing related to performing data conversion in accordance with control of the bandwidth control unit 110.

As shown in the figure, the control unit 104 of the transmission apparatus 1400 is transmitting stream data to a plurality of playback apparatuses. On new receipt of a stream data transfer request from a playback apparatus, the control unit 104 reads video data from the storage apparatus 101, outputs the read video data to the accumulation buffer unit 102, associates a bandwidth necessary for transmission of the video data with the playback apparatus that requested the video data, and outputs the bandwidth to the bandwidth control unit 110. For example, the control unit 104 outputs a requested bandwidth 1900c shown in FIG. 15C to the bandwidth control unit 110.

On receipt of the requested bandwidth 1900c from the control unit 104 (S1601), the bandwidth control unit 110 references the used bandwidth 192 of each record of the playback apparatus management table 1900b and the requested bandwidth 1900c received from the control unit 104, and judges whether the bandwidth necessary for transmission of stream data to the playback apparatuses fits in the total bandwidth of the communication route (S1602).

If the bandwidth necessary for transmission of stream data to the playback apparatuses is judged to fit in the total bandwidth of the communication route (S1602: YES), the bandwidth management subunit 111 updates the playback apparatus management table 1900b, and adds a new record to the playback apparatus management table 1900b, whereby the new record has associated therein the playback apparatus requesting transmission of the stream data, the bandwidth to be used by the playback apparatus, and a conversion flag indicating that conversion of data is not to be performed.

If the bandwidth necessary for transmission of stream data to the playback apparatuses is judged to not fit in the total bandwidth of the communication route in step S1602 (S1602: NO), the bandwidth management subunit 111 references the total bandwidth 1900a and the used bandwidth 192 of each record of the playback apparatus management table 1900b, and calculates a remaining useable bandwidth of the communication route (S1604).

Taking an example from FIG. 15 to describe step S1602 and step S1604, the total bandwidth of the communication route is “20”, as shown in FIG. 15A.

On the other hand, the bandwidth already being used by the playback apparatuses is, as shown in FIG. 15B, “10” for a playback apparatus 1, and “6” for a playback apparatus 2, whereby the total is “16”. As shown in FIG. 15C, the used bandwidth of the stream data pertaining to the new transfer request is “10”.

Consequently, given that the bandwidth necessary for transmission of stream data to the playback apparatuses is “16”+“10”=“26”, which exceeds the total bandwidth “20” of the communication route, the bandwidth control unit 110 judges in step S1602 that the bandwidth necessary for transmission of stream data to the playback apparatus does not fit in the total bandwidth of the communication (S1602:NO).

The bandwidth management subunit 111 then calculates the remaining useable bandwidth of the communication route. The bandwidth management subunit 111 calculates that the remaining useable bandwidth of the communication route is “4” since the total bandwidth of the communication route is “20”, and the bandwidth used by the playback apparatuses 1 and 2 is “16” (S1604).

Continuing the description using FIG. 16, upon calculating the remaining useable bandwidth of the communication route in step S1604, the bandwidth management subunit 111 adds a record pertaining to the playback apparatus indicated in the requested bandwidth 1900c to the playback apparatus management table 1900b. At this time, the conversion flag of the record to be added to the playback apparatus management table 1900b is set to “1” which indicates that the flag is set to ON, and the remaining useable bandwidth of the communication route is recorded in the used bandwidth 192 of the record to be added (S1605).

Taking an example from FIG. 15, as shown in FIG. 15D, no change has been performed in step S1605 to the total bandwidth 1900a, but as shown in FIG. 15E, a record for the playback apparatus indicated in the requested bandwidth 1900c has been added to the playback apparatus management table 1900b in step S1605. “PLAYBACK APPARATUS 3” is recorded in the user number 191 of the added record, the remaining useable bandwidth of “4” is recorded in the used bandwidth 192, and “1” indicating that the flag is set to ON is recorded in the conversion flag 193.

On addition of the new record to the playback apparatus management table 1900b (S1605), the remaining useable bandwidth, that is, information pertaining to the bandwidth that can be allocated to the playback apparatus which newly made a transfer request, is output to the data conversion subunit 112 (S1606).

On receipt of the information pertaining to the remaining useable bandwidth from the bandwidth management subunit 111, the data conversion subunit 112 reads, from the accumulation buffer unit 102, stream data to be transmitted, performs conversion processing on the read stream data, and transfers the converted stream data to the playback apparatus which newly made a transfer request, so as to not exceed the received bandwidth.

Note that conversion processing refers to processing such as re-encoding video data recorded in the MPEG-2 format to the MPEG-4 format, and performing conversion of a bitrate. Taking an example from FIG. 15E, data on which data conversion processing has been performed is being transferred to the playback apparatus 3. Also, data on which data conversion processing has not been performed is being transferred to the playback apparatuses 1 and 2.

In the above-mentioned example, conversion processing is performed on, but not limited to, the stream data read from the accumulation buffer unit 102. Data conversion processing may be performed on data read from the storage apparatus 101, the converted data may be stored in the accumulation buffer unit 102, and the converted data stored in the accumulation buffer unit 102 may be transferred to playback apparatuses.

Once data conversion processing has been performed in this way, and the transmission positions of the stream data being transmitted to the playback apparatuses have been aligned according to control of the control unit 104, the accumulation buffer control subunit 105 of the control unit 104 outputs, to the bandwidth control unit 110, information indicating that the transmission positions of the stream data being transmitted to the playback apparatuses have been aligned. On receipt of this information from the accumulation buffer control subunit 105, the bandwidth control unit 110 deletes information pertaining to the playback apparatus receiving the converted stream data from the playback apparatus management table 1900b, and thereafter transfers data to the playback apparatuses without performing data conversion processing.

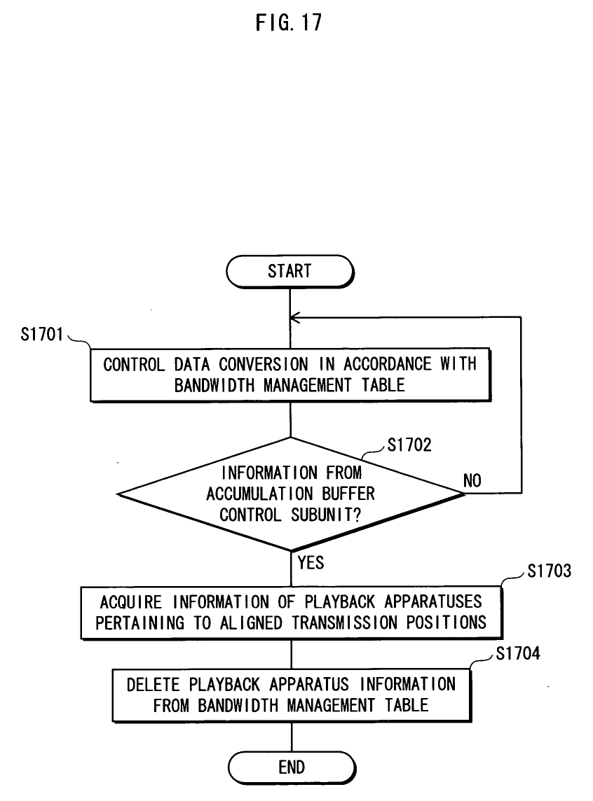

FIG. 17 is a flowchart showing processing related to updating the playback apparatus management table 1900b when transmission positions of stream data have been aligned.

As shown in the figure, stream data on which data conversion processing has been performed by the data conversion subunit 112 is transferred in accordance with the bandwidth management table 1900 (S1701), until the bandwidth control unit 110 receives, from the accumulation buffer control subunit 105, the information indicating that the transmission positions of the stream data have been aligned (S1702:NO).

On receipt of the information indicating that the transmission positions of the stream data have been aligned from the accumulation buffer control subunit 105 (S1702:YES), the bandwidth control unit 110 acquires, from the accumulation buffer control subunit 105, information pertaining to the playback apparatuses corresponding to the aligned transmission positions (S1703), and deletes, from the playback apparatus management table 1900b, information pertaining to the playback apparatus corresponding to the conversion flag 193 indicating that conversion is being performed (S1704).

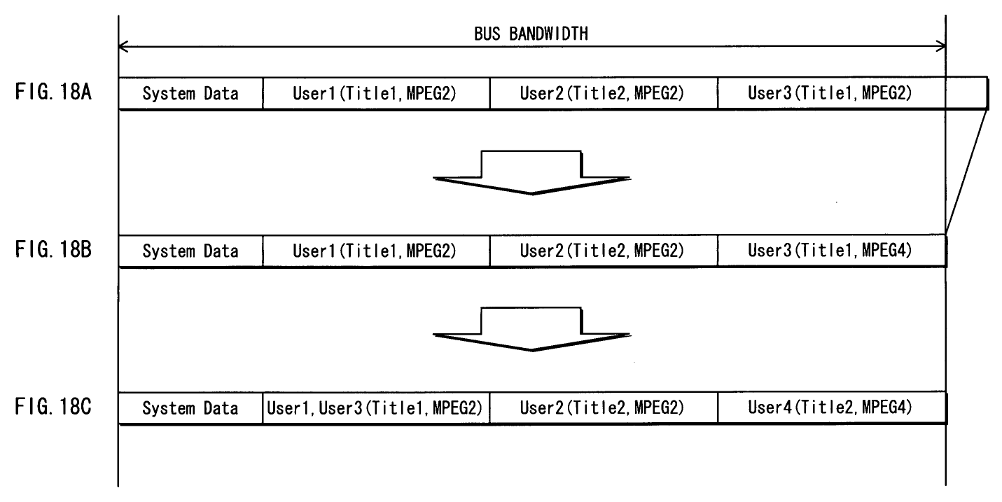

Next is a description of the above-mentioned processing, using FIGS. 18A to 18C.

FIGS. 18A to 18C show bandwidth control performed by the bandwidth control unit 110.

In the figure, a User1 which is a playback apparatus is receiving stream data which is a Title1 recorded in the MPEG-2 format, and a User2 which is a playback apparatus is receiving stream data which is a Title2 recorded in the MPEG-2 format. Here, a User3 which is also a playback apparatus newly requests transfer of the above Title1. As shown in FIG. 18A, the total bandwidth necessary for transfer of SystemData used in communication control, the Title1 being received by the User1, the Title2 being received by the User2, and the Title1 requested by the User3 may exceed the total bandwidth of the communication route.

As shown in FIG. 18B, at this time the bandwidth control unit 110 converts the Title1 newly requested by the User3 from the MPEG-2 format to the MPEG-4 format, such that the total of bandwidth necessary for transfer does not exceed the total bandwidth of the communication route.

Once the transmission positions of the stream data being transmitted to the User1 and the User3, which are both requesting the Title1, have been aligned by the control unit 104, the bandwidth retained for the User3 is freed, and the bandwidth is then allocated to a new playback apparatus User4.

Note that in the above-mentioned example, data conversion processing is performed on, but not limited to, stream data to be transferred to the playback apparatus that made a new transfer request. Data conversion processing may be performed on stream data to be transferred to a playback apparatus which is already receiving stream data.

Although the previously mentioned data conversion processing is performed if stream data is being transmitted to a plurality of playback apparatuses, and a stream data transfer request is newly received from another playback apparatus in the above example, execution of the data conversion processing is not limited to if a stream data transfer request is newly received from another playback apparatus. For example, the previously mentioned data conversion processing may also be performed if any of a plurality of playback apparatuses, to which stream data at the same transmission position is being transmitted, receives a fast-forward operation or the like from a user, and requests stream data at another transmission position.

Supplements

Although embodiments of the present invention are described above, the transmission apparatus pertaining to the present invention is of course not limited to the above-mentioned structures.

(1) Although transmission positions of stream data being transmitted to playback apparatuses are aggregated by controlling amounts of stream data transmitted to the playback apparatuses based on amounts of stream data accumulated in user buffers 153 in the above embodiments, the present invention is not limited to this. Stream data transmission amounts may of course be controlled based on the video data playback speed of each playback apparatus.

Taking the example of users 7 and 8 using the buffer 3 of FIG. 8, the user 8 is playing back video data at one-half of normal speed, whereby the amount of stream data required in a predetermined time period for playback of the video data is less than is required for the user 7.

Consequently, while the user 8 is playing back video data at one-half of normal speed, it is possible to bring closer the transmission positions of stream data being transmitted to the users 7 and 8 by making the amount of stream data transmitted to the user 8 half the amount transmitted to the user 7.

(2) Although an example of the control unit 104 reading video data in units of 1 second is given in the above embodiments, and positions of read video data are stored in units of 1 second in the accumulation buffer 22 and the like in FIG. 2, the unit is not limited to 1 second. Storage may of course be performed in units of 1 frame constituting the stream data.

(3) Although the transmission position of the adjustment user is aligned with the transmission position of the key user in the above embodiments, that is, although the transmission position of a certain playback apparatus is aligned with the transmission position of another playback apparatus, the present invention is not limited to this. Of course, a predetermined transmission position for alignment of other transmission positions may be set, and amounts of stream data transmitted to playback apparatuses may be increased or decreased in order for alignment with the predetermined transmission position.

For example, an intermediate value between the transmission positions of the playback apparatuses targeted for transmission position alignment is set as the predetermined transmission position for alignment of transmission positions, whereby the transmission positions of the playback apparatuses can be aligned with the predetermined transmission position by decreasing the amount of stream data transmitted to a playback apparatus whose transmission position is ahead of the intermediate value, and increasing the amount of stream data transmitted to a playback apparatus whose transmission position is behind the intermediate value.

Also, after the transmission positions of the playback apparatuses have been aligned in an accumulation buffer, transmission of data to the playback apparatuses may be performed using an FIFO buffer that stores data using an FIFO (First-In First-Out) method.

(4) Although aggregation processing that aligns, within the same accumulation buffer, the transmission positions of stream data being transmitted to a plurality of playback apparatuses is performed in the above embodiments, if a single playback apparatus is assigned to a single accumulation buffer, transmission positions of playback apparatuses using different accumulation buffers may of course be aggregated.

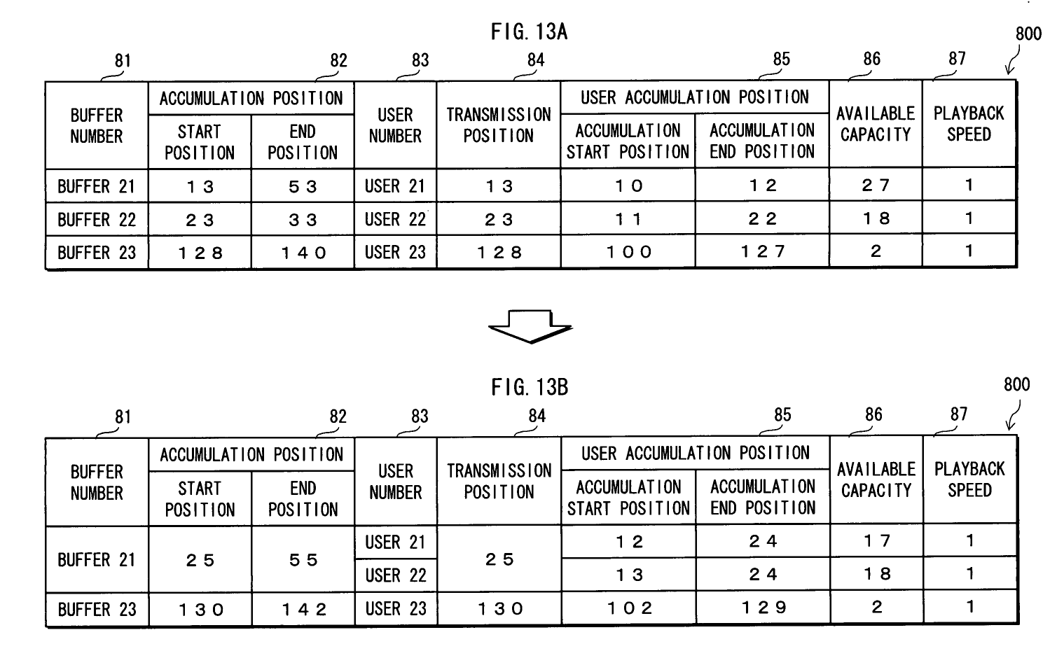

FIGS. 13A and 13B show a transmission position management table 800 in the case of a single playback apparatus being assigned to a single accumulation buffer.

If the transmission positions of playback apparatuses assigned to accumulation buffers are close to each other within a predetermined range, the control unit 104 performs aggregation processing to align the transmission positions of the playback apparatuses by controlling the transmission amount of stream data transmitted to the playback apparatuses.

Taking an example from FIG. 13A, transmission positions of a user 21 assigned a buffer 21 and a user 22 assigned a buffer 22 are to be aligned. Assuming that the transmission positions are to be aligned by increasing the amount of stream data transmitted to the user 21, similar to as described in the above embodiments, the control unit 104 references the available capacity 86 of the user 21, obtains the transmission position difference between the users 21 and 22, and judges, based on the transmission position difference and the available capacity 86, whether the available capacity of the user 21 is sufficient.

In the above example, the transmission position of the user 21 can be aligned with the transmission position of the user 22 by increasing the amount of stream data transmitted to the user 21, since the available capacity 86 is sufficient.

After the transmission positions of stream data transmitted to the playback apparatuses have been aligned, the accumulation buffer used by one of the playback apparatuses can be released, and stream data can be simultaneously transmitted from the accumulation buffer used by the other playback apparatus.

Taking an example from FIG. 13B, stream data can be simultaneously transmitted from the same buffer 21 to users 21 and 22 after the transmission positions of stream data transmitted to the users 21 and 22 have been aligned, thereby enabling the release of the buffer 22 used by the user 22.

Note that the predetermined range may be any range. For example, it may be determined that the transmission positions of playback apparatuses are close to each other within the predetermined range if the difference between the transmission positions is smaller than the maximum amount of stream data that can be accumulated in the user buffers.

(5) Although aggregation processing to align, within the same accumulation buffer, the transmission positions of stream data transmitted to a plurality of playback apparatuses is performed in above embodiments, the present invention is not limited to this. Transmission positions of playback apparatuses using different accumulation buffers may of course be aggregated.

For example, one or a plurality of predetermined transmission positions for the alignment of transmission positions can be managed on the transmission apparatus side, stream data constituting video data can be divided into a plurality of segments using the one or more predetermined transmission positions, and transmission positions of stream data included in the segments can be aligned with the one or more predetermined transmission positions.

For example, a segment may be defined as 60 seconds of stream data. If transmission positions for playback apparatuses are included in the same segment, the transmission positions may be aligned with a predetermined transmission position in the segment.

(6) The above apparatuses may be computer systems structured specifically from a microprocessor, ROM, RAM, a hard disk unit, a display unit, a keyboard, a mouse, etc. A computer program is stored in the RAM or the hard disk unit. The apparatuses achieve their functions as the microprocessor operates in accordance with the computer program. Instruction code which indicates commands to the computer is structured as a combination of multiple instruction codes since the computer program achieves predetermined functions.

(7) A portion or all of the structure elements of the above apparatuses may be structured as a single system LSI (Large Scale Integration). A system LSI is a super multifunctional LSI manufactured by integrating multiple structural units onto a single chip. Specifically, it is a computer system including a microprocessor, ROM, and RAM. A computer program is stored in the RAM. The system LSI achieves its functions as the microprocessor operates in accordance with the computer program.

(8) A portion or all of the structure elements of the above apparatuses may be structured as a removable IC card or stand-alone module. The IC card or the module would be a computer system including a microprocessor, ROM, and RAM. The IC card and the module may also include the above super multifunctional LSI. The IC card and the module achieve their functions as the microprocessor operates in accordance with the computer program. This IC card or module may be tamper resistant.

(9) The present invention may be the methods shown above. Also, the present invention may be computer programs for causing computers to realize the methods, or may be digital signals representing the computer programs.

Also, the present invention may be a computer-readable recording medium such as a flexible disk, a hard disk, a CD-ROM, an MO, a DVD, a DVD-ROM, a DVD-RAM, a BD (Blu-ray Disc), or a semiconductor memory on which the computer programs or the digital signals are recorded. The present invention may be the computer programs or the digital signals which are recorded on these recording media.

Also, the present invention may be the computer programs or digital signals which are transmitted via an electronic communications circuit, a wireless or fixed-line communications circuit, a network acting as an internet, a data broadcast, etc.

Also, the present invention may be a computer system including a microprocessor and a memory, whereby the memory stores the computer program, and the microprocessor operates in accordance with the computer program.

Also, the present invention may be carried out by another independent computer system by transferring the program or the digital signals which have been recorded on the recording media, or by transferring the program or the digital signals via the network, etc.

(10) The above embodiment and the above variations may be combined.

In a system that distributes video data using a video-on-demand method, the present invention is useful in the case of many users utilizing the system.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A transmission apparatus which is connected to a plurality of playback apparatuses via a network, and sequentially transmits stream data according to requests of individual playback apparatuses from among the plurality of playback apparatuses, comprising:
a storage unit operable to prestore the stream data;
a management unit operable to manage a transmission position for each of the plurality of playback apparatuses, the transmission position showing, on a time-axis of the stream data, a position at which transmission is being performed;
a detection unit operable to detect that the transmission positions for at least two of the playback apparatuses are within a predetermined range; and
a transmission control unit operable to control transmission of the stream data so as to align the transmission positions for the at least two playback apparatuses.

2. The transmission apparatus of claim 1, wherein
the transmission control unit performs the control so as to align the transmission positions for the at least two playback apparatuses, by adjusting, based on the transmission positions thereof that are managed by the management unit, a transmission amount of the stream data to be transmitted within a predetermined time period.

3. The transmission apparatus of claim 2, wherein
the transmission control unit performs the transmission amount adjustment by specifying, from among the at least two playback apparatuses, a reference playback apparatus to be a reference for transmission position alignment, and with respect to another playback apparatus from among the at least two playback apparatuses, increasing or decreasing the transmission amount by an amount corresponding to a difference between the transmission position for the reference playback apparatus and the transmission position for the other playback apparatus.

4. The transmission apparatus of claim 2, wherein
each of the plurality of playback apparatuses includes an accumulation unit operable to receive up to a given amount of the stream data and accumulate the received stream data,
the transmission control unit adds or subtracts a predetermined adjustment amount to/from a predetermined reference transmission amount to perform sequential transmission of the stream data,
the transmission apparatus further comprises:
a user buffer management unit operable to acquire, for each of the plurality of playback apparatuses, an accumulation position showing, on the time-axis of the stream data, a position at which the accumulation unit is performing reception and accumulation, and a buffer capacity showing an amount of the stream data that can be accumulated by the accumulation unit, and manage the received accumulation positions and the received buffer capacities; and
a judgment unit operable to judge, based on the accumulation positions and the buffer capacities, whether the accumulation units of the at least two playback apparatuses can accumulate the adjustment amount, and
the transmission control unit performs the transmission amount adjustment only if the judgment by the judgment unit is affirmative.

5. The transmission apparatus of claim 2, wherein
the transmission control unit performs the transmission amount adjustment by, from among the at least two playback apparatuses, increasing the transmission amount with respect to a playback apparatus which pertains to a transmission position that is behind a predetermined position on the time-axis of the stream data, and decreasing the transmission amount with respect to a playback apparatus which pertains to a transmission position that is ahead of the predetermined position on the time-axis of the stream data.

6. The transmission apparatus of claim 2, wherein
the transmission control unit performs the transmission amount adjustment by transmitting stream data from which a part is omitted to, from among the at least two playback apparatuses, a playback apparatus pertaining to a transmission position that is behind on the time-axis of the stream data compared with another one of the at least two playback apparatuses.

7. The transmission apparatus of claim 1, wherein
segments of the stream data are defined,
the detection unit performs the detection if a plurality of transmission positions are included in one of the segments, and
the transmission control unit controls transmission of the stream data so as to align the transmission positions of the at least two playback apparatuses to a predetermined position in the one of the segments.

8. The transmission apparatus of claim 1, wherein
after the transmission positions for the at least two playback apparatuses have been aligned by the transmission control unit, a portion that is a predetermined amount of the stream data is read from the storage unit, the portion is input to a single FIFO buffer, and the stream data is output from the FIFO buffer to the at least two playback apparatuses.

9. The transmission apparatus of claim 1, further comprising:
a bandwidth management unit operable to manage used bandwidth on the network with respect to the stream data at differing transmission positions;
a judgment unit operable, if the stream data is being transmitted and a transfer request for the stream data pertaining to another transmission position is newly received, to judge whether a total used bandwidth of the stream data to be transmitted exceeds a total bandwidth of the network; and
a bandwidth control unit operable, if the total used bandwidth is judged by the judgment unit to exceed the total bandwidth, to transmit converted stream data on which data conversion processing has been performed to at least one of the plurality of playback apparatuses, such that the total used bandwidth does not exceed the total bandwidth, wherein
the transmission control unit performs the control so as to align the transmission position pertaining to the converted stream data with another one of the transmission positions.

10. The transmission apparatus of claim 9, wherein
upon alignment of the transmission position pertaining to the converted stream data with the other one of the transmission positions by the transmission control unit, transmission of the converted stream data is stopped to free the used bandwidth thereof, and the stream data pertaining to the other one of the transmission positions is transmitted to the playback apparatus to which the converted stream data was transmitted.

11. A content distribution system including a transmission apparatus that sequentially transmits stream data to a plurality of playback apparatuses according to requests from the plurality of playback apparatuses, and the plurality of playback apparatuses that receive the stream data requested from the transmission apparatus and playback the received stream data,
each of the plurality of playback apparatuses comprising:
an accumulation unit operable to receive up to a given amount of the stream data and accumulate the received stream data; and
a distribution unit operable to distribute, based on an instruction of the transmission apparatus, the stream data accumulated by the accumulation unit to another of the plurality of playback apparatuses, and
the transmission apparatus comprising:
a storage unit operable to prestore the stream data;
a user buffer management unit operable to acquire and manage, for each of the plurality of playback apparatuses, an accumulation position showing, on a time-axis of the stream data, a position at which the accumulation unit is performing reception and accumulation, and a buffer capacity showing an amount of the stream data that can be accumulated by the accumulation unit;
an accumulated data detection unit operable, if there is a transmission request for the stream data from a first playback apparatus, to detect that the stream data requested by the first playback apparatus has been accumulated by a second playback apparatus; and
a playback apparatus control unit operable, if the detection has been performed, to control the second playback apparatus such that the distribution unit thereof distributes the stream data from the second playback apparatus to the first playback apparatus.
